(19) United States
(12) Patent Application Publication
(10) Pub. No.: US 2012/0248163 A1
(43) Pub. Date: Oct. 4, 2012

(54) Play or Work Apparatus

(76) Inventor: Solvej Dilys Biddle, Berkshire (GB)

(21) Appl. No.: 13/508,290

(22) PCT Filed: Nov. 4, 2010
(86) PCT No.: PCT/EP10/66841

§ 371 Date: Jun. 19, 2012

(30) Foreign Application Priority Data
Nov. 5, 2009 (GB) GB0919439.0

(51) Int. Cl. B60R 7/00

(52) U.S. Cl. 224/275

(57) ABSTRACT

An apparatus is provided comprising a first portion and a second portion connected by a hinge, the first portion comprising a flap and two side walls arranged to extend from the flap, wherein the flap and side walls are arranged to cooperatively define a first enclosure accessible from a front end opposite the hinge.

This invention relates to a portable play or work apparatus.

Any parent will be aware of the problem of how to keep their child entertained without them creating a mess. This problem occurs, for example, on long journeys, where the child has to sit in a passenger seat of a vehicle for long periods. A particularly challenging form of travel in this regard is a long-haul flight. A child with nothing to do while on the aeroplane will tend to become restless. Alternatively, if a child is given things with which to occupy him or her, those items are likely to fall onto the floor or into the aisle. Constantly retrieving a child's lost toys from various parts of the aeroplane is a considerable inconvenience to the parent.

On most flights, passengers can fold down a tray table attached to the back of the seat in front of them. This, at least, provides a surface on which the child can put his or her toys. However, tray tables are generally unsuitable for this task as they has a relatively small top surface and toys can easily fall off. Likewise, many motor vehicles and trains have similar tray arrangements.

A large variety of bags, rucksacks, etc. are available for children to carry their toys. Some of these bags are of a suitable size for being carried by the child and can be used as hand luggage during a flight. In order for the child to use the toys on the aeroplane the toys must be removed from the bag. Furthermore, the bag will usually be most conveniently stored in an overhead storage compartment. The toys are removed from the bag and the problems associated with loose items for which the child is nominally responsible as referred to above will arise. At the end of the flight, the toys will need to be gathered together from the various parts of the passenger accommodation and put back into the bag. Such bags do not solve the problem of the scattering of toys in the course of the journey. The present invention addresses the drawbacks of the prior art.

These problems are addressed by an apparatus as defined in claim 1 and by a closable enclosure as defined in claim 22. Additional optional features are set out in the dependent claims.

In some embodiments, the apparatus comprises a body portion and a flap portion connected to be articulated. The flap portion comprises a flap which is movable about the region of articulation relative to the body portion to define open and closed configurations of the apparatus.

In some embodiments, the flap can be opened and positioned to rest on a work surface, such as a tray table. The flap, a pair of side walls and a front wall extending from the flap cooperatively define an enclosure. The flap provides a surface to be used instead of the surface of the tray table. The walls help to prevent the child's toys from falling off the surface.

In some embodiments, the front wall is reconfigurable to open the enclosure at the front wall end. When the front wall is in position between the side walls, it can act as an obstacle to a child who wants to use the surface for (e.g.) writing or drawing. The front wall, when in position, would get in the way of the child's hand, wrist or forearm, preventing the child's forearm from being positioned in a comfortable writing position resting on the surface. The front wall can therefore be reconfigured so that it no longer acts as an obstacle and allows the child to comfortably use the surface for writing or drawing while providing side walls to prevent items from falling on the floor.

Another drawback of tray tables in various modes of transport is that their depth is relatively shallow, i.e. they do not extend very far from the back of the seat in front of the passenger towards the passenger. Tray tables on aeroplanes are usually designed so that they can be used comfortably by a large adult. They can sometimes be pulled toward the passenger but this leaves a gap at the back. However, a small child will generally have considerable room between his or her body and the front of the tray table even when it is pulled forward, providing another gap for items to fall through.

In some embodiments, the apparatus provides a deployable flap extension, which enables the surface provided by the flap to extend further towards the child when the child is sitting in the seat. This creates a larger surface for the child to place his or her toys.

In some embodiments, the flap extension has its own side walls and its own front wall extending between the side walls in a similar manner to the walls of the flap. The extension walls also prevent the child's toys from falling off the edge of the surface of the flap extension.

In some embodiments, the flap extension can be positioned at an angle with respect to the flap so that the front of the flap extension is declined from the flap towards the floor. The flap extension can be configured so that its rests on the child's lap to fill the gap. The declined angle of the flap extension ensures that the extension front wall does not act as a hindrance to the child when the child is using the surface provided by the flap and/or the flap extension for writing or drawing.

In some embodiments, the extension front wall is reconfigurable in a similar manner to the front wall to open the enclosure defined by the flap extension, extension side walls and extension front wall. In some embodiments, the front edge of the flap extension is concave to fit around the child's abdomen while providing a large surface area for the flap extension.

In some embodiments, the front wall is reconfigurable such that the flap extension and the flap combine to form a continuous surface. The side walls form continuous walls with the respective extension side walls and define with the extension front wall, the flap and the flap extension a combined enclosure.

In some embodiments, the flap extension, extension side walls and extension front wall are configurable in an unextended configuration in which each of the flap extension, extension side walls and extension front wall are positioned adjacent and parallel to one or more of the flap, side walls or front wall. This ensures that the flap extension and its walls do not take up unnecessary space in the apparatus when they are not being used.

In some embodiments, the body portion is arranged to provide storage means for the child's toys.

In some embodiments, the apparatus is suitable to be used in conjunction with a laptop by a person of any age. As such, the recreational enclosure becomes a work area. Again, adults are not immune from dropping mobile office paraphernalia and the enclosure provided by the apparatus is of use in this context as well.

The invention will now be described by way of example with reference to the accompanying drawings in which:

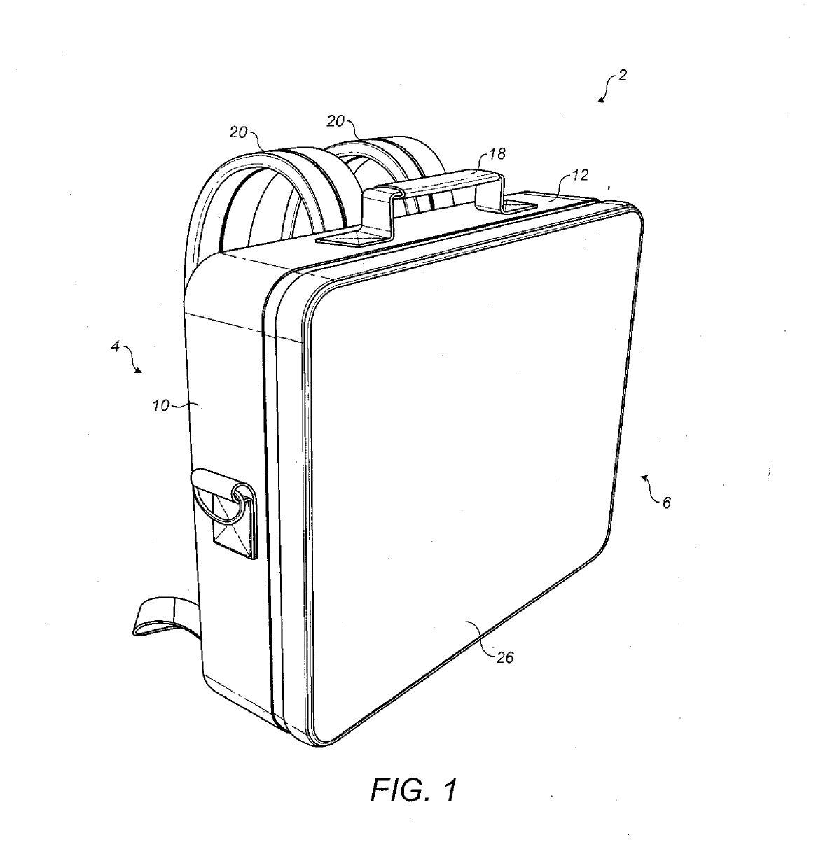

FIG. 1 depicts a perspective view of an apparatus in a closed configuration;

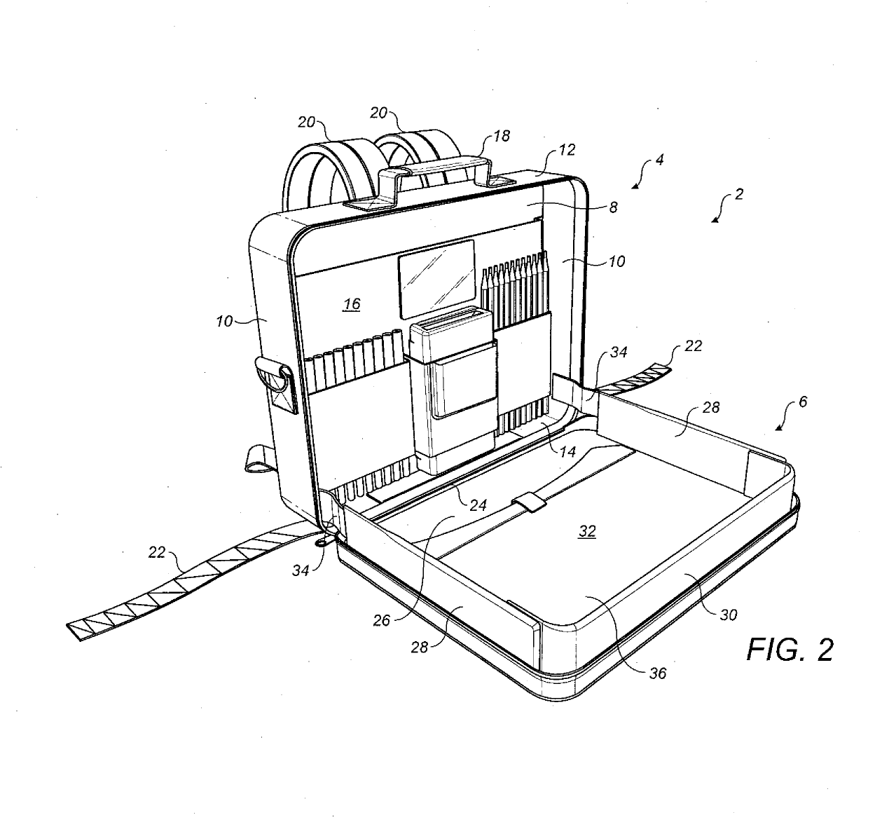

FIG. 2 depicts a perspective view of the apparatus in an open and unextended configuration;

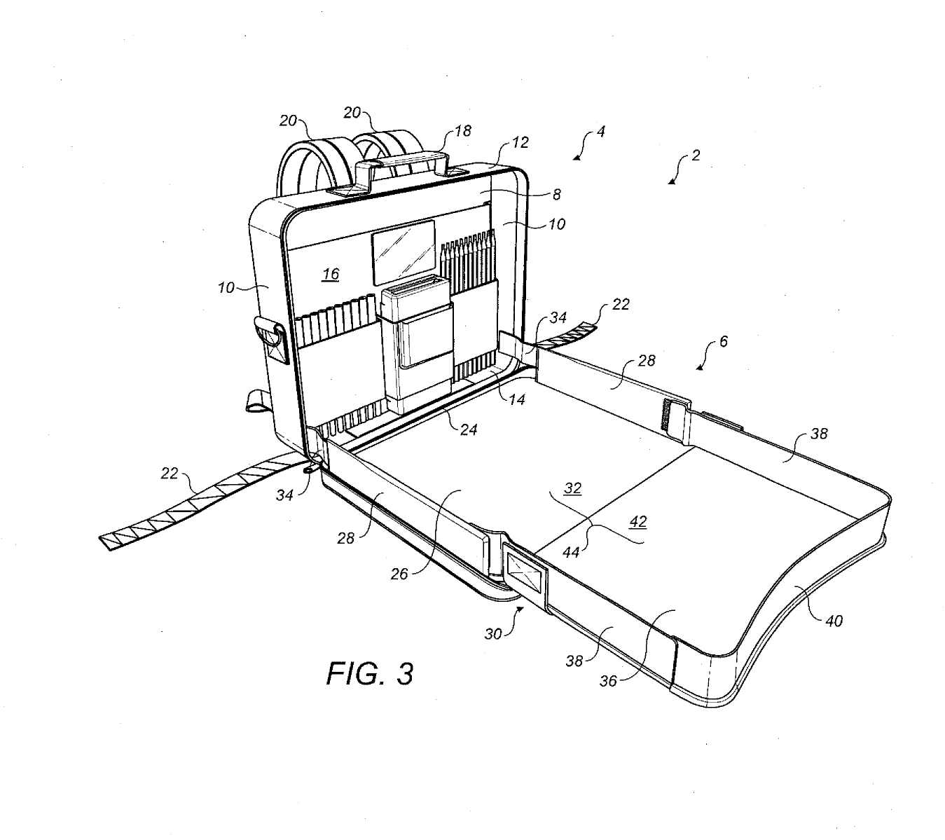

FIG. 3 depicts a perspective view of the apparatus in an open and extended configuration; and

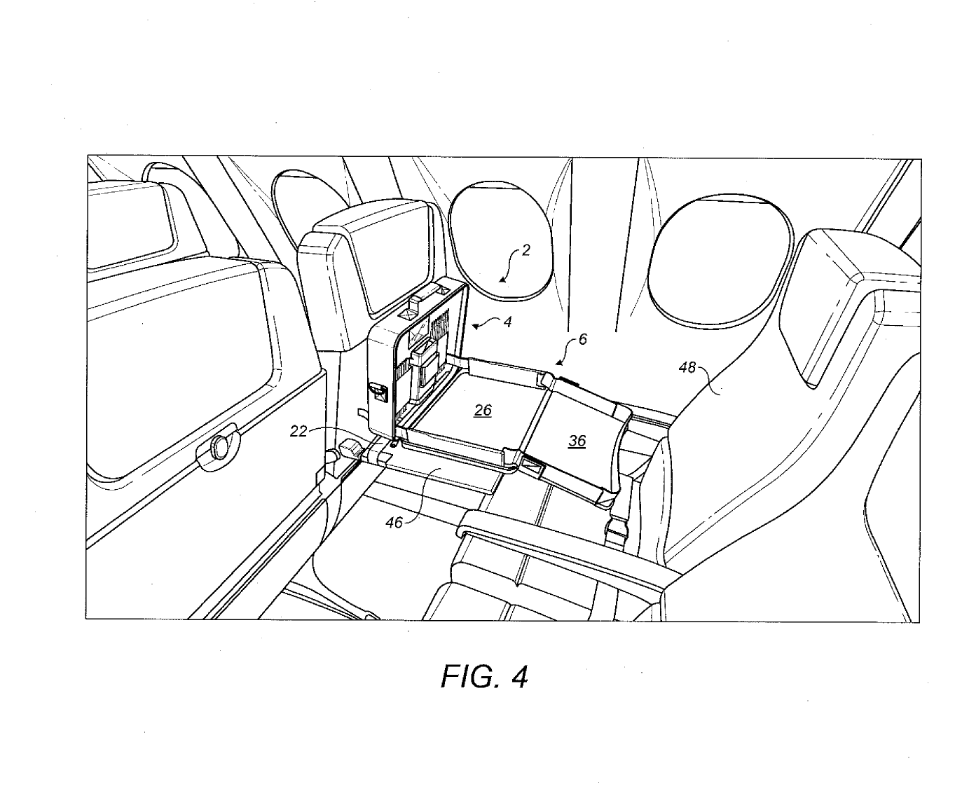

FIG. 4 depicts a perspective view of the apparatus in the open and extended configuration positioned on a tray table in an aeroplane seating system.

With reference to FIG. 1, an apparatus 2 has a body portion 4 and a flap portion 6. The apparatus 2 is shown in a closed configuration. With reference to FIGS. 1 and 2, the body portion 4 comprises a body main wall 8, two body side walls 10, a body front wall 12 and a body rear wall 14. The two body side walls 10 extend from two shorter sides of the rectangular body main wall 8 in a direction substantially perpendicular to the body main wall 8. The body front wall 12 extends between the two body side walls 10 and from a front edge of the body main wall 8. The body front wall 12 is therefore substantially mutually perpendicular to the body side walls 10 and the body main wall 8. The body rear wall 14 extends from a rear edge of the body main wall 8 and between the two body side walls 10. The body rear wall 14 is therefore substantially parallel to the body front wall 12 and substantially perpendicular to the body side walls 10 and to the body main wall 8. Where each of the body side walls 10 meet the body front wall 12 and the body rear wall 14, the corners between them are rounded.

The body main wall 8, body side walls 10, body front wall 12 and body rear wall 14 act to cooperatively define a body enclosure 16 on the inside of the apparatus 2. Inside the body enclosure 16 are compartments for retaining the child's toys and stationery.

The body front wall 12 has a handle 18 on the outside of the apparatus 2. In effect, this embodiment serves as a carrying case as well as a play area. The body portion 4 also comprises a pair of shoulder straps 20, each of which is connected to the body front wall 12 and the body rear wall 14 on the outside of the apparatus 2. The shoulder straps 20 enable the apparatus 2 to be carried like a rucksack.

The body portion 4 also comprises a securing strap 22. The securing strap 22 extends parallel to the rear wall on the inside of the apparatus 2. Where the securing strap 22 extends away from the centre of the apparatus 2 towards each of the body side walls 10, the securing strap 22 passes through a hole in the body rear wall 14 so that it is external to the apparatus 2. The two ends of the securing strap 22 are attachable. This is achieved by means of Velcro® pads on each end of the securing strap 22. Other forms of attachment are possible such as other Velcro-like products, riplock seals, clips, buckles, buttons, etc.

When the securing strap 22 is not in use, it can be retracted into the apparatus 2 so that the majority of the securing strap 22 is held within the apparatus 2.

A hinge 24 is located along the edge of the body rear wall 14 that is furthest from the body main wall 8. The hinge 24 defines a hinge axis, which is substantially parallel to the body main wall 8. The hinge 24 connects the body portion 4 to the flap portion 6.

The flap portion 6 comprises a flap 26, which, in the closed configuration, acts as a lid of the apparatus 2. In the closed configuration, the flap 26 is substantially parallel to the body main wall 8. The flap 26 is substantially the same shape as the body main wall 8. The flap 26 and the body portion 4 can be secured in the closed configuration by a zip. Other forms of closure are also possible such as belts and buckles, ties, Velcro® connections, etc.

With reference to FIG. 2, an open and unextended configuration of the apparatus 2 is shown. In order to open the apparatus 2, the zip is unfastened, and the flap portion 6 is rotated away from the body portion 4 about the hinge axis. In the open configuration, the flap 26 is positioned substantially perpendicular to the body main wall 8. The preferred orientation of the apparatus 2 when in the open configuration is for the flap 26 to rest on a substantially flat horizontal surface, and the body main wall 8 to extend substantially vertically above this surface.

The inside of the flap portion 6 can also be seen in FIG. 2. Two side walls 28 extend from and substantially perpendicular to the flap 26. These side walls 28 are substantially rectangular and are positioned opposite each other at opposite sides of the flap 26. A front wall 30 extends between the two side walls 28. The front wall 30 extends from the flap 26 at the front edge of the flap 26 (i.e. the edge furthest from the hinge 24). The front wall 30 therefore is substantially parallel to the hinge axis. The flap 26, side walls 28 and front wall 30 combine to cooperatively define a flap enclosure 32. The flap enclosure 32 is also bounded on its rear side by the body portion 4.

Each of the side walls 28 is connected to its respective body side wall 10 by a retaining strap 34. The retaining straps 34 are flexible but hold the body portion 4 and the flap 26 at a maximum angle of about 90°. The retaining straps 34 help the body portion 4 to remain essentially upright when the flap 26 is resting on a horizontal surface.

The front wall 30 of the flap portion 6 is attached to each of the side walls 28. This attachment is achieved by two end portions of the front wall 30, which extend parallel to the side walls 28 along a relatively small length of the side walls 28 on the inside of the side walls 28. The end portions of the front wall 30 and the adjacent portions of the side walls 28 contain cooperating Velcro® pads which allow the front wall 30 to be attached to the side walls 28. In this open and unextended configuration, the apparatus 2 can be put into the closed configuration without the side walls 28 or the front wall 30 having to be moved with respect to the flap 26. In the closed configuration, the side walls 28 and the front wall 30 extend into the body enclosure 16 inside the body side walls 10 and the body front wall 12.

With reference to FIG. 3, an open and extended configuration of the apparatus 2 is described. It can be seen that the flap portion 6 also comprises a flap extension 36, two extension side walls 38 and an extension front wall 40. It can also be seen that the front wall 30 is no longer in its position between the two side walls 28 but is collapsed beneath the flap extension 36. The flap extension 36 extends from the front wall 30 end of the flap 26 and forms a continuous surface with the flap 26. The extension side walls 38 extend from the respective sides of the flap extension 36. The extension side walls 38 are substantially perpendicular to the flap extension 36 and are substantially co-planar with the respective side walls 28. The extension side walls 38 are attached to the side walls 28 to form two continuous side walls. A rear end portion of each extension side wall 38 contains a Velcro® pad which is attached to the same Velcro® pad on the corresponding side walls 28 to which the front wall 30 is attached when the apparatus 2 is in the open and unextended configuration.

At the front end of the flap extension 36, an extension front wall 40 extends from the flap extension 36 in a direction perpendicular to the flap extension 36. The extension front wall 40 extends between the extension side walls 38 and is attached to the extension side walls 38 in the same way that the front wall 30 is attached to the side walls 28 in the open and unextended configuration (i.e. the extension side walls 38 have a front portion with a Velcro® pad on it and the extension front wall 40 has two end portions with cooperating Velcro® pads).

The front end of the flap extension 36 (and hence the extension front wall 40) is concave. This helps to prevent the flap extension 36 from pressing into the child's abdomen when the apparatus 2 is in use, whilst maintaining a large area of the top surface of the flap extension 36.

The flap extension 36, extension side walls 38 and extension front wall 40 therefore combine to cooperatively define an extension enclosure 42. Given that the front wall 30 is no longer in its position between the two side walls 28, the flap 26, flap extension 36, side walls 28, extension side walls 38 and extension front wall 40 combine to cooperatively define a combined enclosure 44.

With reference to FIGS. 2 and 3, the procedure of converting the apparatus 2 from its open and unextended configuration to its open and extended configuration is now described. The flap extension 36 is in a hinged relationship with the flap 26 so that the flap extension 36 can be folded with respect to the flap 26. The axis of this folding hinge is at the connection between the flap extension 36 and the flap 26. This folding axis is substantially parallel to the hinge axis.

In the open and unextended configuration, the flap extension 36 is folded on top of the flap 26 so that the flap extension 36 is substantially parallel to the flap 26 and resting against it. The extension side walls 38 are folded so that they are resting against the flap extension 36 such that in the unextended configuration they are between the flap extension 36 and the flap 26.

In the unextended configuration, the extension front wall 40 is not attached to the extension side walls 38 but lies in the same plane as the flap extension 36. In order to convert the apparatus 2 from the open and unextended configuration to the open and extended configuration, firstly the flap extension 36 is unfolded away from the flap 26 so that it extends substantially perpendicular to the flap 26. At this stage, the front wall 30 is detached from the two side walls 28. The flap extension 36 can then be further unfolded away from the flap 26. This further unfolding causes the front wall 30 to rotate about its connection with the flap 26. The flap extension 36 is then unfolded so that it is substantially parallel to the flap 26. At this stage, the front wall 30 is parallel to the flap extension 36 and situated underneath the flap extension 36. The end portions of the front wall 30 that were attached to the side walls 28 are at this stage extending vertically, passing outside the flap extension 36. The extension side walls 38 are then unfolded so that they extend perpendicularly to the flap extension 36. The extension front wall 40 is also folded from its position parallel to the flap extension 36 to its position perpendicular to the flap extension 36. The extension front wall 40 is then attached to the extension side walls 38 as described above and the extension side walls 38 are attached to the side walls 28 as described above. The end portions of the front wall 30 can provide additional support to the extension side walls 38.

With reference to FIG. 4, the use of the apparatus 2 in a passenger seating system such as that of an aircraft is described. The apparatus 2 is situated on a tray table 46 in front of a passenger seat 48 of the user of the apparatus 2. The tray table 46 extends towards the passenger seat 48 from the back of the seat in front. The securing strap 22 is wrapped around the tray table 46 and the ends of the securing strap 22 are fastened together. This secures the apparatus 2 to the tray table 46 and prevents the apparatus 2 from falling off the tray table 46. The angle of the flap extension 36 with respect to the flap 26 can be altered by adjusting the Velcro® pads on the rear ends of the extension side walls 38 that attach to the cooperating Velcro® pads on the front ends of the side walls 28. The Velcro® pads are of a large enough size to allow the flap extension 36 to be secured at various angles. Alternatively, the extension side walls 38 can be left unattached to the side walls 28. This allows the flap extension 36 to hang down so that it will rest in the lap of the child when the child is in the seat.

When the apparatus 2 is in the open configuration, the hinge 24 biases the apparatus 2 open. This ensures that the body portion 4 does not fall back onto the flap portion 6 while the apparatus 2 is in use in the open configuration. This hinge arrangement also allows the apparatus 2 to be used in a situation where the back of the seat in front of the passenger seat 48 is at an acute angle to the tray table 46. The body portion 4 can therefore be held at an acute angle to the flap portion 6 without it closing.

It will be understood that the above description of specific embodiments of the invention is by way of example only and is not intended to limit the scope of the invention. Many modifications of the described embodiments, some of which are now described, are envisaged and are intended to be covered by the appended claims.

In some embodiments, the front wall 30 is removable from the side walls 28 and the flap 26. The flap enclosure 32 can then be opened at its front wall 30 end by simply removing the front wall 30.

In some embodiments, the extension front wall 40 and the front wall 30 are formed by the same component. In the open and unextended configuration, this component forms the front wall 30 as described above. The front wall 30 is then removed and the apparatus 2 is reconfigured to the open and extended configuration. At this stage, the component is attached to the extension side walls 38 as described above to form the extension front wall 40. The component is bendable so that it corresponds to the concave front end of the flap extension 36 when it is used to form the extension front wall 40.

In some embodiments, the extension front wall 40 is held in its position to correspond to the concave front end of the flap extension 36 by a rim extending from the front end of the flap extension 36 in substantially the same direction as the extension front wall 40. The rim supports the extension front wall 40 so as to help it to maintain its position and orientation. In some embodiments, the extension front wall 40 is attachable to the rim by one or more corresponding Velcro® pads on the extension front wall 40 and the rim.

In some embodiments, one or more rims similar to that described above extend from the flap 26 and/or the flap extension 36 to support one or more of the side walls 28, the front wall 30, and/or the extension side walls 38. The skilled person will appreciate that there are many possible combinations in this respect.

In some embodiments, a flap rim extends around the front end and both sides of the flap 26 to support the side walls 28 and the front wall 30. In some embodiments, part of the zip for securing the flap 26 and the body portion 4 in the closed configuration is located on the flap rim.

In some embodiments, the flap extension 36 is in a telescopic relationship with the flap 26. In the open and unextended configuration, the flap extension 36 is situated underneath (or, in other embodiments, above) the top surface of the flap 26. To configure the apparatus 2 in the open and extended configuration, the flap extension 36 is slid from this position to a position substantially as described above. In some of these embodiments, the extension front wall 40 is formed from the same component as the front wall 30, i.e. it slides with the flap extension 36.

Similarly, the extension front wall 40 is, in some embodiments, removable from the extension side walls 38 and the flap extension 36 to open the extension enclosure 42 (and hence the combined enclosure 44) at the extension front wall 40 end.

In some embodiments, the depth of the top surface of the flap extension 36 is approximately 50%, 75% or 100% of the depth of the top surface of the flap 26.

In some embodiments, the front end of the flap extension 36 and, hence, the extension front wall 40, is substantially flat, rather than being concave.

In some embodiments, the side walls 28 are removable from the flap 26. In some embodiments the side walls 28 are foldable with respect to the flap 26 so that they can be folded to rest against the flap 26. In some embodiments, the front wall 30 is foldable towards the flap 26 so that it can be folded against the flap 26.

Although the above description refers to a particular arrangement of folding the various walls and the flap extension 36, the skilled person will be able to envisage other configurations. For example, the extension side walls 38 are, in some embodiments, foldable through an angle of approximately 270° relative to the flap extension 36 between their positions in the open and extended configuration and the open and unextended configuration.

In some embodiments, the flap portion 6 also comprises part of or all of the exterior side walls, front wall and rear wall of the apparatus 2 when the apparatus 2 is in the closed configuration.

In some embodiments, the apparatus 2 does not include the flap extension 36, the extension side walls 38 or the extension front wall 40. In some of these embodiments, the front wall 30 is still reconfigurable to open the flap enclosure 32 at the front wall 30 end.

In some embodiments, the hinge 24 does not have a rigid axis but is a living hinge made of material or a suitable plastics material to define the articulation between the body portion 4 and the flap portion 6.

In some embodiments, the apparatus 2 comprises means for securing the body portion 4 and the flap portion 6 in the closed configuration. Although a zip provided this function in the embodiments described above, the skilled person will be aware of various other ways that this function could be performed. Examples, include buckles, ties, magnetic strips, etc.

In some embodiments, the apparatus 2 comprises means for securing the apparatus 2 with respect to a table, such that the flap 26 rests against the table.

In the embodiments described above, this feature is performed by a securing strap 22 that can be wrapped around the tray table 46. In some embodiments, there are two securing straps, with one securing strap extending from each side of the body rear wall 14. The two securing straps are attachable to each other.

In some embodiments, instead of or as well as the apparatus 2 having one or more securing straps, the flap 26 comprises one or more friction pads on its outer surface to prevent movement of the apparatus 2 with respect to the tray table 46 when the apparatus 2 is situated on the tray table 46. The skilled person will also be aware of various other ways that these functions can be achieved.

In some embodiments, the apparatus is a case as referred to above. The apparatus is dimensioned to fit on a typical fold-down tray table of a commercial passenger aircraft. It can be bigger or smaller than this for other applications. Conveniently the shape and size of the apparatus makes it portable, preferably by the child.

At various parts of the above description, various components are described as being attached by Velcro® pads. Other means for attaching the various components are used in some embodiments. The skilled person will be aware of various possibilities in this respect. Examples include zips, ties, magnetic strips, etc.

In some embodiments, various combinations of pockets, storage means, or other accessories are stored within the body portion 4.

1. An apparatus comprising a first portion and a second portion connected by a hinge, the first portion comprising a flap and two side walls arranged to extend from the flap, wherein the flap and side walls are arranged to cooperatively define a first enclosure accessible from a front end opposite the hinge.

2. An apparatus as claimed in claim 1, wherein the first portion comprises a front wall arranged to extend from the flap between the two side walls at the front end to define a front boundary of the first enclosure, wherein the front wall is reconfigurable such that the first enclosure is open from the front end.

3. An apparatus as claimed in claim 2, wherein the front wall is foldable with respect to the flap to open the first enclosure at the front end.

4. An apparatus as claimed in claim 2, wherein the front wall is removable from the flap to open the first enclosure at the front end.

5. An apparatus as claimed in claim 2, wherein the front wall is detachable from the side walls.

6. An apparatus as claimed in claim 1, wherein the first portion comprises a flap extension arranged to extend from the front end of the flap, and wherein the flap extension is foldable with respect to the flap between an unextended configuration, in which the flap extension rests against the flap, and an extended configuration, in which the flap extension is substantially coplanar with the flap.

7. (canceled)

8. An apparatus as claimed in claim 6, wherein the first portion comprises two extension side walls arranged to extend from the flap extension, and wherein the extension side walls are arranged to extend from the respective side walls.

9. (canceled)

10. An apparatus as claimed in claim 8, wherein the first portion comprises an extension front wall arranged to extend from the flap extension between the two extension side walls, wherein the flap extension, extension side walls and extension front wall are arranged to cooperatively define an extension enclosure.

11. An apparatus as claimed in claim 10, wherein the extension front wall is reconfigurable such that the extension enclosure is open from the extension front end, and wherein the apparatus is configurable such that the first enclosure and the extension enclosure are continuous and form a combined enclosure.

12. (canceled)

13. An apparatus as claimed in claim 10, wherein the extension front end of the flap extension is concave.

14. An apparatus as claimed in claim 10, wherein the flap extension, extension side walls and extension front wall are reconfigurable to allow the flap extension to rest against the flap in the unextended configuration.

15. An apparatus as claimed in claim 14, wherein the extension side walls and/or the extension front wall are foldable with respect to the flap extension to allow the flap extension to rest against the flap in the unextended configuration.

16. An apparatus as claimed in claim 15, wherein the extension side walls and/or the extension front wall are removable from the flap extension to allow the flap extension to rest against the flap in the unextended configuration.

17. An apparatus as claimed in claim 1, wherein the first portion and the second portion are configurable in a closed configuration in which the first portion and the second portion are secured with respect to each other, and wherein the hinge is a living hinge.

18. (canceled)

19. An apparatus as claimed in claim 1, wherein the apparatus comprises means for securing the apparatus with respect to a table, such that the flap rests against the table, and wherein the apparatus comprises a strap for strapping the apparatus to the table so that the flap rests on the table.

20. (canceled)

21. A case comprising the apparatus in claim 1.

22. A closable play or work enclosure comprising base and lid members connected by a hinge and means biasing the members into an open configuration, the base member defining a substantially flat working surface and the lid member including at least one storage compartment.

23. The closable enclosure of claim 22, wherein the base member comprises two side walls arranged to extend upwardly from the working surface, wherein the working surface and side walls are arranged to cooperatively define the enclosure, the enclosure being accessible from a front end opposite the hinge.

24. The closable enclosure of claim 23, wherein the base member comprises a front wall arranged to extend from the working surface between the two side walls at the front end to define a front boundary of the enclosure, wherein the front wall is reconfigurable such that the enclosure is open from the front end, and wherein the front wall is reconfigurable by folding or being removable.

25. (canceled)

26. A case comprising the closable enclosure of claim 22.
